(19) United States
(12) Patent Application Publication
(10) Pub. No.: US 2009/0182451 A1
(43) Pub. Date: Jul. 16, 2009

(54) METHOD FOR CONTROLLING TURNING MACHINING AND NC MACHINES SUITABLE FOR TURNING MACHINING

(75) Inventors: Johannes Jennessen, Schwalmtal (DE); Norbert Olah, Düsseldorf (DE); Stefan Peschke, Dormagen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/302,663

(22) PCT Filed: May 3, 2007
(86) PCT No.: PCT/EP07/54304

§ 371 Date: Nov. 26, 2008

(30) Foreign Application Priority Data
May 29, 2006 (DE) 10 2006 024 974.7

(51) Int. Cl. G06F 19/00; B23B 9/00

(52) U.S. Cl. 700/188; 82/118

(57) ABSTRACT

The invention relates to a modern method for the turning machining of appropriate machines, on which a workpiece (10) with a cutting edge (16) acts on a workpiece (18), with the machines displaying a round B axis around which the workpiece as a whole can be rotated, and a round C axis by the rotation of which the workpiece rotates around its own axis. Software developed up to now does not contain steps for providing the round axes. Thus, software is used to generate control instructions for the machine as a function of the input data which provide the geometry and position of a workpiece in reference to the resting position of a round axis and which corresponds to a respective rotation of 0° approximately. Then, software that computes certain values (cutting edge position, direction of the main cut, mounting angle, and relief angle) is attached to this software. The input data for the base software can then be derived from these values. A simulation of the computation steps shows that a new workpiece exhibiting another geometry is provided when the workpiece is rotated. The base software can provide the control instructions for the workpiece in a way that results in a correct machining of the workpiece.

The invention relates to a method for controlling turning machining by a machine which is numerically controlled with the aid of a control device, in particular a lathe, in which a tool 10 with a cutter acts on a workpiece, with a first (B) round shaft being provided about which the tool can rotate as an entity, and a second (C) round shaft is provided, during whose rotation the tool rotates about its own axis. The invention also relates to a machine which is suitable for turning machining and is numerically controlled with the aid of a control device, as claimed in the precharacterizing clause of patent claim 4.

Lathes or machines which are generally suitable for turning machining (and which may also be milling machines) increasingly more frequently have the capability to rotate the tool with the blade as an entity (B round shaft), in some cases also with the supplementary capability for it to be rotated about its own axis (C round shaft).

It has not been possible for the technical development of the control of turning machining to keep completely in step with the provision of these round shafts. While software which requires the shape (geometry) of the tool and its position as input data is available for machines which are suitable for turning machining but do not have the said round shafts, software such as this does not exist for machines which have both said round shafts. In the prior art, the data is thus preprocessed with the aid of a CAD/CAM system (computer aided design/computer aided manufacturing), and the individual cycles (machining steps for numerically controlled operation of the machine) are prepared.

It would be desirable to also be able to take account of the rotation about the round shafts in a control device for the numerically controlled machine.

EP 1 217 481 A1 describes a controller for a cutting machine in which the values of the offset of a tool in two coordinate directions are calculated and displayed as a function of a rotation angle of the tool.

EP 1 235 125 A2 describes a controller for a cutting machine in which the length of a tool from its cutting edge to a rotation axis thereof is taken into account in the case of rotation of the tool.

The object of the invention is to provide a method for controlling turning machining of the generic type mentioned initially and a machine which is suitable for turning machining as claimed in the precharacterizing clause of patent claim 4, which has/have been developed such that the control device produces all the control commands and in the process takes account of the rotation about the two round shafts.

The object is achieved by a method having the features as claimed in patent claim 1 and by a machine, which is suitable for turning machining, having the features of patent claim 4.

The method according to the invention therefore comprises the following steps:
a) provision of software in the control device, which produces control commands for the machine as a function of input data which presets the geometry and position of a tool with respect to a basic position of the round shafts,
b) determination or presetting of the cutter position, of the main cutting direction, of the holder angle and of the clearance angle for the tool in the basic position of the round shaft by the control device,
c) movement of the tool to any desired machining position by rotation about the round shafts and determination of the rotation angle about the round shafts in comparison to the basic position of the round shafts,
d) calculation of the cutter position, of the main cutting direction, of the holder angle and of the clearance angle for the tool in the machining position by the control device,
e) conversion of the data calculated in step d) by the control device to input data for the software provided in step a), by redefinition of the actual tool in the machining position to a modified (virtual) tool in the basic position,
f) production of the control commands for the tool in the machining position with the aid of the software provided in step a).

The invention therefore does not provide completely new software. In fact, the existing software is used. Software which uses input data defined with respect to a basic position of the round shafts is nothing more than software which takes no account whatsoever of the position of the round shafts. Since the data calculated in step d) is compared with the data determined (or likewise calculated) in step b), this makes the conversion step e) possible. In this case, so to speak, a “new” tool is defined, to be precise with the actual tool being virtually converted to a modified tool, with the modified tool being predetermined with respect to the basic position. In other words, rotation about the round shafts, which affects the input data, results in a change to the tool; that is to say the geometry and position of the tool are changed. This allows the rotation to be mapped onto the input data in such a way that the software provided in step a), which does not know about the rotation about the round shafts, can be used (step f)).

By way of example, the so-called position 2 (cf. FIG. 2) is defined as a basic position, in which case the nomenclature used here for the positions is intended to be the standardized position nomenclature for numerically controlled machines.

In one preferred embodiment, the input data, in particular the input data related to the geometry, comprises the length of the tool. This length of the tool is a length that is used as an input data item. This is based on the assumption that the cutter is rounded, but that a model of the cutter without rounding can be used for calculation of the cutter to be used. The length is related to the model of the cutter. The calculation of the length takes into account, corresponding to step e) of rounding of the cutter when the cutter position in the machining position is different from the cutter position in the basic position. The reason for this is that the model of the cutter changes depending on the position of the tool, as a result of which the length defined by the model of the cutter must also be changed.

The machine according to the invention, which is suitable for turning machining, is characterized in that, in the control unit:
a) basic software is stored which can produce control commands for a machine without the first and second round shafts from input data which presets the geometry and the position of a tool,
b) control software is stored for the round shafts,
c) applied software is stored which can calculate the cutter position, the main cutting directions, the holder angles and the clearance angles for the tool in any desired machining positions which are defined by rotation of the round shafts, and can convert these to input data for the basic software.

This description illustrates how the control unit must operate. The basic software per se is conventional software from the prior art, in which the rotations about the two round shafts are not considered. Specific software is applied to this software, which makes input data available for the basic software such that the machining steps are carried out correctly even in the event of rotation about the round shafts. Control software is provided for the actual rotation for the round shafts.

The invention, in particular the concepts required for the invention, will be explained in more detail in the following text with reference to the drawing, in which:

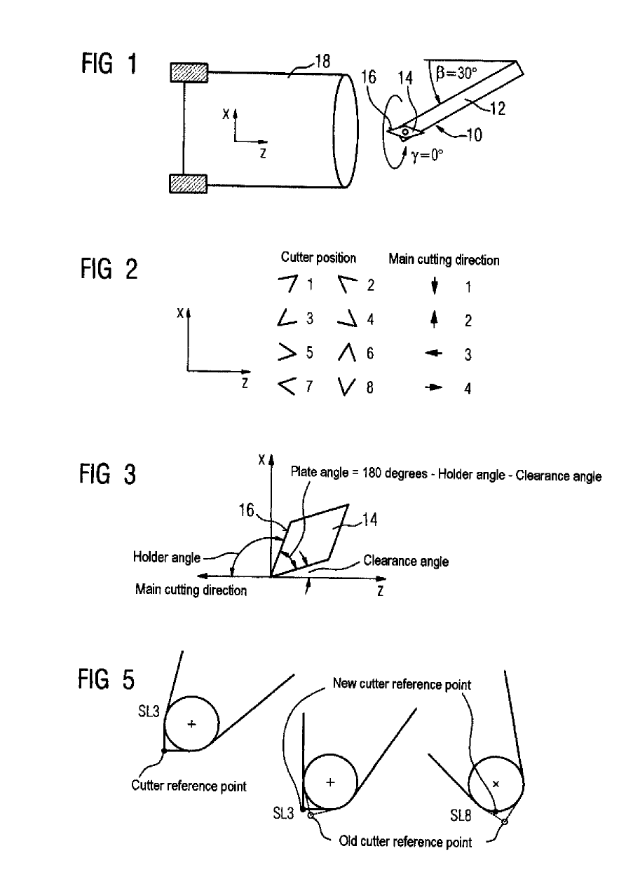

FIG. 1 shows, schematically, a tool on a workpiece, with the rotations which are made possible by the two round shafts being explained,

FIG. 2 shows the definition of cutter positions and main cutting directions,

FIG. 3 shows the definition of the terms holder angle, plate angle and clearance angle,

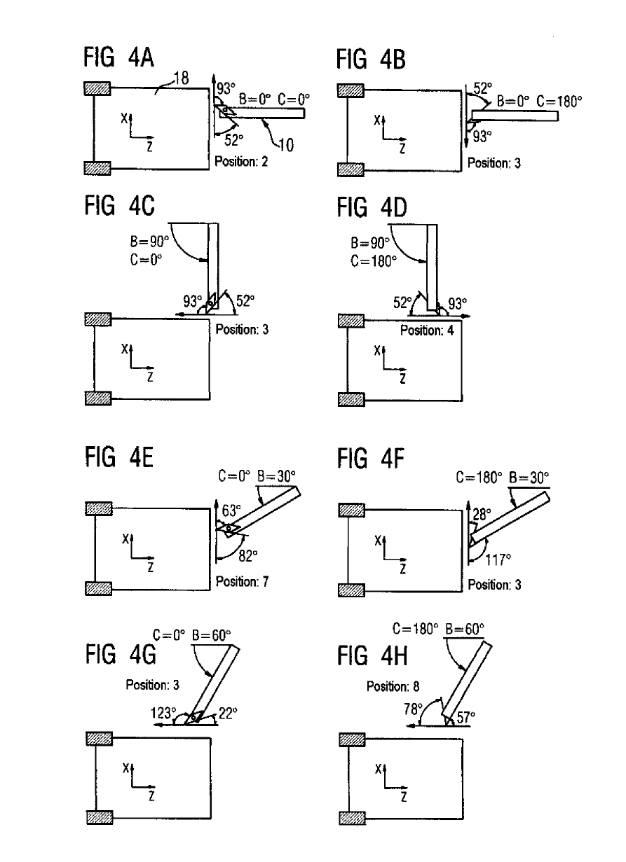

FIGS. 4A to 4H show the cutter position, the cutting direction, the holder angle and the clearance angle for various rotation-angle combinations during rotation about the B round shaft and the C round shaft,

FIG. 5 shows the position dependency of the cutter reference point to be taken into account for calculating the length of the tool.

The invention relates in general to a machine having the arrangement shown in FIG. 1: A tool 10 with a shank 12 and a plate 14 which has a cutter 16 machines a workpiece 18. A machine such as this may be a lathe. Modern milling machines have the same functionality, that is to say they are also suitable for turning machining. A first round shaft, the so-called B round shaft, is provided in the lathe, about which the tool 10 can rotate as an entity, that is to say with its shank 12. The illustration in FIG. 1 shows a machining position in which the tool has been rotated through an angle of β=30° about the B round shaft. Furthermore, a second round shaft is provided, a so-called C round shaft, which allows the tool to rotate about itself. The illustration shows a machining position in which the basic position of the C round shaft is being assumed, that is to say the rotation angle γ=0°.

Eight cutter positions are normally defined in a numerically controlled machine. (Occasionally there is a ninth cutter position but this does not correspond to a machining position). The eight cutter positions are illustrated in FIG. 2 in comparison to a coordinate system of the workpiece 18. The illustration shows the axes x and z of the coordinate system. The main cutting directions are also defined with respect to this coordinate system. The main cutting directions are the directions in which the cutter 16 or possibly the entire tool 10 is moved. The main cutting direction 1 illustrated in FIG. 2 corresponds to a movement in the −x direction, the main cutting direction 2 corresponds to a movement in the +x direction, the main cutting direction 3 illustrated in FIG. 2 corresponds to a movement in the −z direction, and the main cutting direction 4 corresponds to a movement in the +z direction.

The further variables used for the purposes of the invention, the holder angle and the clearance angle, will now be explained with reference to FIG. 3. The illustration shows the tool plate 14 with the cutter 16 in the cutter position 3. The main cutting direction is the −z direction. The holder angle is the angle between the cutter 16, that is to say the plate 14, and the line defined by the main cutting direction. The clearance angle is the angle between the plate 14 and the inverse main cutting direction, that is to say in the present case between the plate 14 and the +z axis. The plate angle is added to the holder angle and the clearance angle to form 180°. In the present invention, the patent claims refer to determination of clearance angles and holder angles. This also covers the situation in which the plate angle is measured and only either the holder angle or the clearance angle is determined, and the respective other angle is then also defined, and can be calculated, automatically.

FIGS. 4A to 4H show the four variables determined in the case of the invention, specifically the position, the main cutting direction, the clearance angle and the holder angle for various rotation angles about the B round shaft (the angle β in FIG. 1) and about the C round shaft (the angle γ in FIG. 1).

In the situation in which the rotation angle about both round shafts is=0 (FIG. 4A), this results in the cutter position 2, the main cutting direction 2, a holder angle of 93° and a clearance angle of 52°.

In the situation in which rotation about the B round shaft results in the 0° position (or no rotation has been initiated) and a 180° rotation has taken place by means of the C round shaft (FIG. 4B), this results in the cutter position 3, a main cutting direction in the −x direction, a holder angle of 93° and a clearance angle of 52°.

FIG. 4C shows the situation in which a 90° rotation has been initiated by means of the B round shaft, and a 0° rotation about the C round shaft is defined. In this case this results in the cutter position 3, the main cutting direction −z, a holder angle of 93° and a clearance angle of 52°.

FIG. 4D shows the situation in which a rotation through 90° has been initiated about the B round shaft, and a rotation through 180° has been initiated about the C round shaft. This then results in the cutter position 4, the +z direction as the main cutting direction, a holder angle of 93° and a clearance angle of 52° C.

FIG. 4E shows the situation in which the B round shaft has been rotated through 30° and the C round shaft has remained in the 0° position. This results in the cutter position 7, a main cutting direction +x, a holder angle of 63° and a clearance angle of 82°.

FIG. 4F shows the situation in which a rotation through 30° has taken place by means of the B round shaft and a rotation through 180° C. by means of the C round shaft. This results in the cutter position 3, the direction +x as the main cutting direction, a holder angle of 28° and a clearance angle of 117°.

FIG. 4G shows the situation in which a rotation through 60° has taken place by means of the B round shaft and the C round shaft has remained in the 0° position. This results in the cutter position 3, the −z direction as the main cutting direction, a holder angle of 123° and a clearance angle of 22°.

FIG. 4H shows the situation in which a rotation through 60° has taken place about the B round shaft and a rotation through 180° about the C round shaft. This results in the cutter position 8, the −z direction as the main cutting direction, a holder angle of 78° and a clearance angle of 57°.

The angle variables determined with reference to FIGS. 4A to 4H can in principle be calculated once they have been determined for one specific position, for example the basic position from FIG. 4A (cutter position 2). Each of the four variables is used in the invention to calculate a virtual tool, to be precise from the view of the tool 18. The fact that the tool 10 is moved to different positions can be interpreted as meaning that a “new” tool is provided from a specific view on each occasion. This view necessarily assumes software which is programmed for the basic position as shown in FIG. 4A, but does not know the other positions corresponding to FIGS. 4B to 4H. This software can then be used for further processing when the tool is in each case redefined. In other words, the input data, related to the tool, for the software is changed. This input data can be calculated on the basis of the variables shown in FIGS. 4A to 4H, that is to say the cutter position, the main cutting direction, the holder angle and the clearance angle, together with the known geometry of the tool. The software, which is related to the basic position corresponding to FIG. 4A, can therefore also be used to produce control signals for the tool 10 in the positions corresponding to FIGS. 4B to 4H.

The following detail may play a role in determining the geometry of the tool. The cutter 16 is in general rounded. However, the calculations are in each case carried out as if this were an ideal cutter, which is not rounded. A cutter reference point is determined in each case.

FIG. 5 shows the cutter reference point for one specific position of the tool in the cutter position 3 (left-hand part of FIG. 5).

In the central part of FIG. 5, a slight rotation has taken place in comparison to the left-hand part of FIG. 5, but it remains unchanged at the cutter position 3. The new cutter reference point (see the solid line) shown in the central part of FIG. 5 is defined such that the virtual contour, as is illustrated by the solid line, also remains aligned in the same way as before the rotation in the left-hand part of FIG. 5. The old cutter reference point is therefore not also rotated, as is indicated by the dotted line.

The right-hand part of FIG. 5 now shows a radical rotation of the tool 10 in comparison to the left-hand part of FIG. 5. In this case, the cutter position has now changed, specifically having been rotated from the cutter position 3 to the cutter position 8. The cutter reference point is now defined completely differently, to be precise on the actual rounded contour (see the right-hand part of FIG. 5), while the old cutter reference point is represented by a dashed line. The point where the cutter reference point is located therefore changes since the cutter position is changed. The nature of the definition is changed. Thus, in particular, if the cutter position is varied, the virtual length of the tool, which plays a role in the geometry definition, is changed. If, as described above, software which is matched to the basic state as shown in FIG. 4A is used, and the rotated tool is described from the view of this basic state as a new tool with a changed geometry, then this length change can be taken into account.

The invention provides the capability to use software which is intended for a machine which is suitable for turning machining but does not have a B round shaft or a C round shaft, in addition when rotation about the B round shaft and about the C round shaft must also be taken into account, per se.

The previous software is then used as basic software, and software which adapts the input data for the basic software is applied thereto. Instead of regarding a tool with a given geometry as having been rotated, this is therefore a different tool from the view of the basic software. The data cutter position, main cutting direction, holder angle and clearance angle illustrated in FIGS. 4A to 4H are converted to input data by means of the applied software.

1.-4. (canceled)

5. A method for controlling turning machining operation of a machine which comprises a tool with a cutter acting on a workpiece and is numerically controlled by a control device, the method comprising the steps of:
defining a first rotation axis about which the tool rotates in its entirety,
defining a second rotation axis about which the tool rotates,
supplying input data defining a geometry and a position of the tool with respect to a basic position of the first and second rotation axes,
producing with the control device from the input data control commands for the machine,
determining or presetting with the control device first data representing a first cutter position, a first main cutting direction, a first holder angle and a first clearance angle for the tool for a basic position of the rotation axes,
moving the tool to a desired machining position through a rotation about the rotation axes and determining a rotation angle about the rotation axes in relation to the basic position of the rotation axes,
computing with the control device second data representing a second cutter position, a second main cutting direction, a second holder angle and a second clearance angle for the tool in the machining position,
converting with the control device the second data to modified input data for a modified tool in the basic position, and
producing with the control device from the modified input data control commands for the machine.

6. The method of claim 5, wherein the machine is a lathe.

7. The method of claim 5, wherein first data representing a first cutter position, a first main cutting direction, a first holder angle and a first clearance angle for the tool for a basic position of the rotation axes are predefined.

8. The method of claim 5, wherein the input data further comprise a length of the tool, and wherein computing a corresponding second length as part of the second data includes taking into account rounding of the cutter, if the second cutter position is different from the first cutter position.

9. A numerically controlled turning machine, comprising:
a tool having a cutter operating on a workpiece and configured to rotate about a first rotation axis in its entity, and configured to rotate about a second rotation axis defines as its own axis, and
a control device for controlling operation of the turning machine, the control device comprising
a basic software program generating control commands for the machine from input data which define the geometry and the position of a tool without taking into consideration the first and second rotation axes,
a control software program for the first and second rotation axes, and
a supervisory software which calculates data comprising a cutter position, main cutting directions, holder angles and clearance angles for the tool in any machining position defined by the rotation axes, and converts the data to input data for the basic software for generating control commands for the machine.

10. The machine of claim 9, wherein the machine is a lathe.
